(19) United States
(12) Patent Application Publication
(10) Pub. No.: US 2003/0074240 A1
(43) Pub. Date: Apr. 17, 2003

(54) Method for developing a strategic customer-value-driven plan to create high growth business opportunities

(76) Inventors: Gary Kaiser, Ft. Collins, CO (US); Soren Kaplan, Walnut Creek, CA (US); Michael Northcott, Vancouver, WA (US); Steve Sato, Camas, WA (US); Amy Silverman, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 09/974,846

(22) Filed: Oct. 12, 2001

(51) Int. Cl. G06F 17/60

(52) U.S. Cl. 705/7

(57) ABSTRACT

A method for systematically and consistently developing a strategic plan to create high growth business opportunities is disclosed. The method includes the steps of performing an initiation meeting, performing a pre-invent session, performing pre-work and performing an invent session. The method further designs a business opportunity environment, develops the business opportunity environment, demonstrates the business opportunity environment and refines a business plan. Additionally, the method performs an alignment meeting, performs a commitment meeting and markets a pilot. Another method for systematically and consistently developing a business opportunity is also disclosed. The method includes the steps of performing an initiation meeting, performing a pre-invent session, performing pre-work and performing an invent session. The method further validates a business venture, designs a business opportunity environment, develops the business opportunity environment and demonstrates the business opportunity environment. Additionally, the method refines a business plan, performs an alignment meeting, performs a commitment meeting and markets a pilot. A computer readable medium on which is embedded computer software comprising a set of instructions for executing one or more of the above mentioned methods is also disclosed.

### FIELD OF THE INVENTION

This invention relates generally to business methods, and more particularly, although not exclusively, to developing strategic business plans.

### BACKGROUND OF THE INVENTION

It is generally known that most business interests wish to be profitable. In this regard, a business interest may devote considerable resources into developing a business strategy and a salable product or service (i.e., business opportunity). However, many companies are unable to systematically and consistently identify, develop, and create substantial new growth opportunities for the business interest. As a result, many companies focus on incremental innovations that include adding new features to existing products and services, marketing existing products to new markets, and other activities that generally build business slowly.

A business interest utilizing incremental innovations may experience lackluster growth and thus, may not receive market recognition. Without market recognition, sales may falter, competitors may gain market share, and growth opportunities may not arise. To address this issue, there exists a body of business strategy literature. This literature may be broadly categorized as: disruptive technologies, discontinuous innovation, strategy innovation, and s-curves. Additionally, the business interest may employ general consulting models and frameworks focused on customer research, design research, product development, and business strategy. However, these “solutions” are not solutions at all, but rather, they are retrospective descriptions and anecdotes that describe broad approaches and philosophy regarding the process of creating market disruptions and growth opportunities.

### SUMMARY OF THE INVENTION

In one respect, the invention pertains to a method for systematically and consistently developing a strategic plan to create high growth business opportunities. The method includes the steps of performing an initiation meeting, performing a pre-invent session, performing pre-work and performing an invent session. The method further includes the steps of designing a business opportunity environment, developing the business opportunity environment, demonstrating the business opportunity environment and refining a business plan. Additionally, the method includes the steps of performing an alignment meeting, performing a commitment meeting and marketing a pilot.

In another respect, the invention pertains to a method for systematically and consistently developing a business opportunity. The method includes the steps of performing an initiation meeting, performing a pre-invent session, performing pre-work and performing an invent session. The method further includes the steps of validating a business venture, designing a business opportunity environment, developing the business opportunity environment and demonstrating the business opportunity environment. Additionally, the method includes the steps of refining a business plan, performing an alignment meeting, performing a commitment meeting and marketing a pilot.

In yet another respect, the invention pertains to a computer readable medium on which is embedded computer software comprising a set of instructions for executing a method of systematically and consistently developing a strategic plan to create high growth business opportunities. The method includes the steps of performing an initiation meeting, performing a pre-invent session, performing pre-work and performing an invent session. The method further includes the steps of designing a business opportunity environment, developing the business opportunity environment, demonstrating the business opportunity environment and refining a business plan. Additionally, the method includes the steps of performing an alignment meeting, performing a commitment meeting and marketing a pilot.

In comparison to known prior art, certain embodiments of the invention are capable of achieving certain aspects, including some or all of the following: (1) identify and define a business opportunity designed to offer a compelling value to customers; (2) translate opportunities into specific high growth business plans and concepts; (3) move concepts into prototypes and (4) move prototypes into a business that leads to rapid market adoption. Those skilled in the art will appreciate these and other aspects of various embodiments of the invention upon reading the following detailed description of a preferred embodiment with reference to the below-listed drawings.

### BRIEF DESCRIPTION OF THE DRAWINGS

FIG. 1 is an exemplary diagram of a method for developing a strategic business plan according to an embodiment of the invention;

FIGS. 2 is a more detailed diagram of the step 200 depicted in FIG. 1, according to an embodiment of the invention;

FIGS. 3 is a more detailed diagram of the step 300 depicted in FIG. 1, according to an embodiment of the invention;

FIGS. 4 is a more detailed diagram of the step 400 depicted in FIG. 1, according to an embodiment of the invention;

FIGS. 5 is a more detailed diagram of the step 500 depicted in FIG. 1, according to an embodiment of the invention;

FIGS. 6 is a more detailed diagram of the step 600 depicted in FIG. 1, according to an embodiment of the invention;

FIGS. 7 is a more detailed diagram of the step 700 depicted in FIG. 1, according to an embodiment of the invention;

FIGS. 8 is a more detailed diagram of the step 800 depicted in FIG. 1, according to an embodiment of the invention;

FIGS. 9 is a more detailed diagram of the step 900 depicted in FIG. 1, according to an embodiment of the invention;

FIGS. 10 is a more detailed diagram of the step 1000 depicted in FIG. 1, according to an embodiment of the invention;

FIGS. 11 is a more detailed diagram of the step 1100 depicted in FIG. 1, according to an embodiment of the invention;

FIGS. 12 is a more detailed diagram of the step 1200 depicted in FIG. 1, according to an embodiment of the invention; and

FIGS. 13 is a more detailed diagram of the step 1300 depicted in FIG. 1, according to an embodiment of the invention.

### DETAILED DESCRIPTION OF A PREFERRED EMBODIMENT

For simplicity and illustrative purposes, the principles of the invention are described by referring mainly to an exemplary embodiment thereof. However, one of ordinary skill in the art would readily recognize that the same principles are equally applicable to, and can be implemented in, a system capable of developing a wide range products, services and content associated with business opportunities, and that any such variations are within the scope of the invention. While in the following description numerous specific details are set forth in order to provide a thorough understanding of an embodiment of the invention, in other instances, well known methods and structures have not been described in detail so as not to obscure the invention.

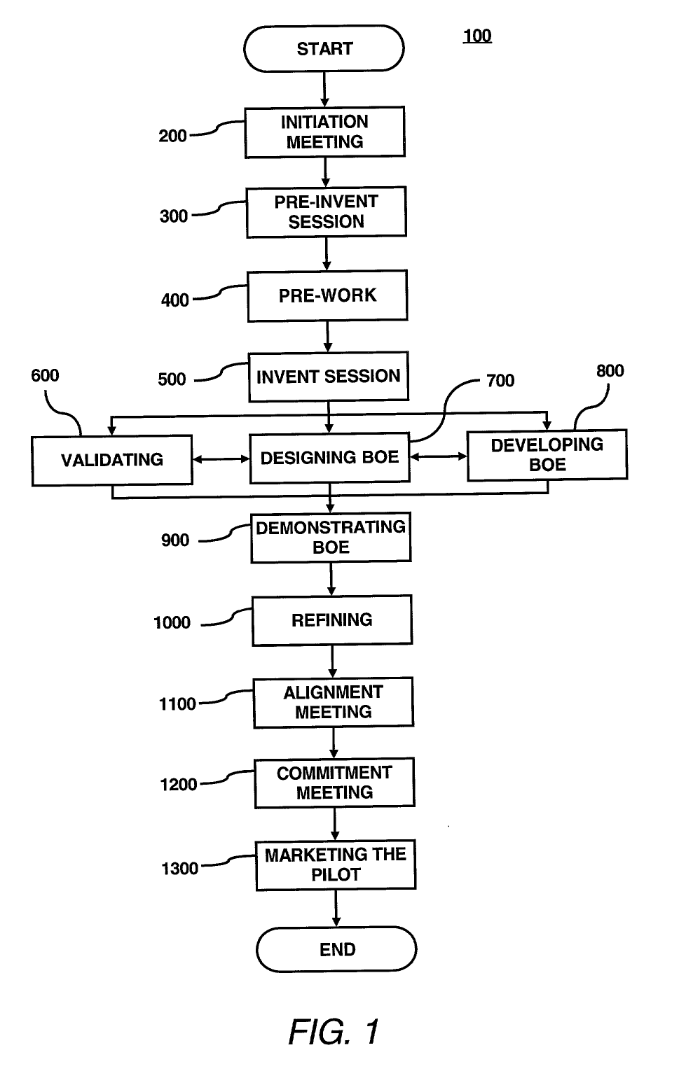

FIG. 1 is an exemplary diagram of a method 100 for developing a strategic business plan according to an embodiment of the invention. As shown in FIG. 1, the method 100 includes a step 200 of performing an initiation meeting, a step 300 of performing a pre-invent session, a step 400 of performing pre-work, a step 500 of performing an invent session, a step 600 of validating a business venture, a step 700 of designing a business opportunity environment (“BOE”), a step 800 of developing the BOE, a step 900 of demonstrating the BOE, a step 1000 of refining a business plan, a step 1100 of performing an alignment meeting, a step 1200 of perform a commitment meeting and a step 1300 of marketing a pilot.

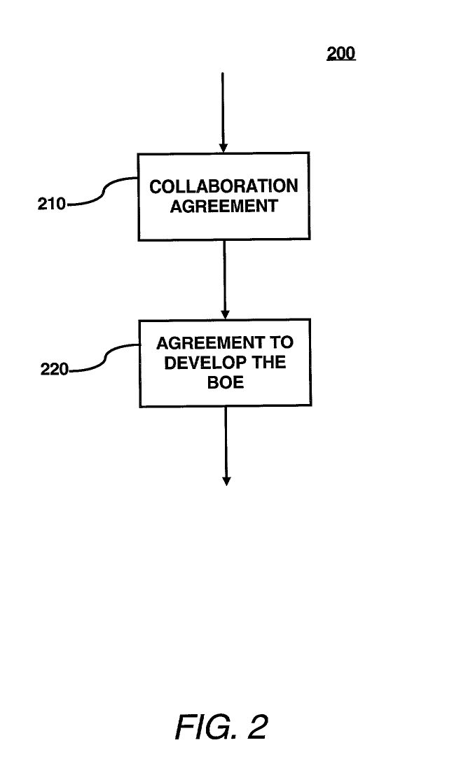

The step 200 may include a step 210 of executing an agreement to collaboratively proceed throughout the method 100, according to an embodiment of the invention, as shown in FIG. 2. The term “executing” is defined as verbal or non-verbal forms of authorizing an agreement. In a preferred form, executing may be performed by one or more individuals or participants with authority for each of the business interests involved. The agreement for a collaborative invent process may be a standard contractual agreement between two or more parties or participants. For example, in a manner similar to known collaborative agreements, joint venture agreements, and the like, the agreement for the collaborative invent process may contain language binding the business interests to operate in good faith. The step 210 may further contain a non-disclosure agreement. Additionally, the agreement for the collaborative invent process may contain language describing an intent by the business interests to develop one or more business opportunities. In another form, the participants of the step 200 may not execute an agreement, but rather, may agree to continue with the method 100. For example, the participants may defer execution of the agreement until one or more goals of the method 100 are identified.

As shown in FIG. 2, the step 200 may further include a step 220 of executing an agreement to develop the BOE. The BOE is defined as an idealized or hypothetical environment in which the business opportunity may be utilized by one or more customers. Additionally, the BOE may include supporting infrastructure, as well as a physical location. For example, if the business opportunity is a new cellular phone with instant messaging capabilities, then the BOE may be a city in which many friends of the customer already have this phone, so the customer could instantly communicate with the friends. Further, the city may include the supporting infrastructure necessary to utilize the phone. In a manner similar to the step 210, the participants of the step 220 may execute the agreement to develop the BOE, thus signifying intent to move forward in the method 100.

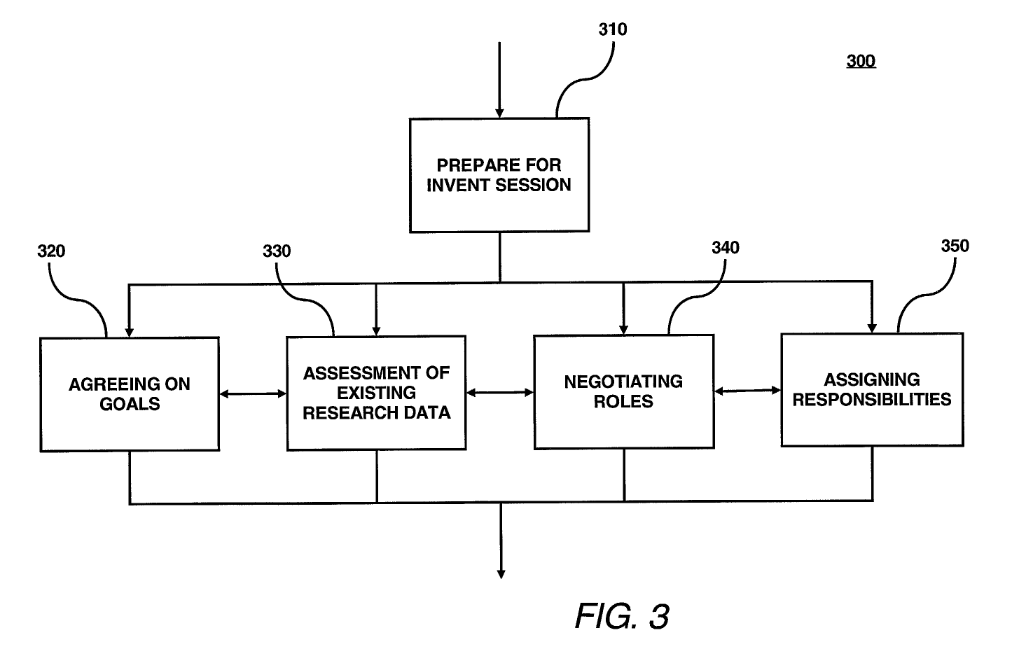

FIG. 3 shows the step 300 according to an embodiment of the invention. In general, the step 300 may pertain to performing customer/partner planning. As shown in FIG. 3, the step 300 may include a step 310 of preparing for an invent session, a step 320 of agreeing goals, a step 330 of performing an assessment of existing research data, a step 340 of negotiating roles, and a step 350 of assigning responsibilities.

In general, the participants of the step 300 are expected to develop goals of the collaboration. In this regard, the participants may identify intended customer segments (e.g., men, women, teenagers, baby boomers, etc.) and potential environments in which the new product or service may be delivered. Once identified, the customer segments and potential environments may set the context for the invent session described below. Additionally, the participants may identify one or more specific goals in the step 300. If the agreement for the collaborative invent process has not been executed, the participants of the step 300 may execute the agreement in response to identifying one or more goals.

In the step 310, the participants may generate and gather data associated with the business opportunity, the intended customer segments and potential environments (e.g., gather research data). The participants may additionally begin formulating one or more specific goals for the method 100. In this regard, the participants may define and agree upon the one or more specific goals in the step 320. Further in step 320, the participants may agree upon one or more tasks or roles intended to accomplish some or all of the goals.

In step 330, the participants may perform an assessment of the existing research data. In this regard, the participants may present the research data gathered. The research data may be evaluated based on a variety of criteria. For example, in a manner known to those of ordinary skill in the art, a statistical significance may be determined based on the number of possible data points verses the number of data points gathered. In another example, a diagram of the research data in part and/or as a whole may be generated as a visual aid to assist the participants in their assessment. In this manner, the participants may assess the research data and determine whether required data has been gathered.

In step 340, the participants may agree upon a role that each business interest may play in accomplishing some or all of the goals. In step 350, the participants may assign one or more responsibilities with due dates to some or all of the business interests. The responsibilities may include attaining a subset of the agreed upon goals. In general, responsibilities may be assigned based on resources available to each business interest.

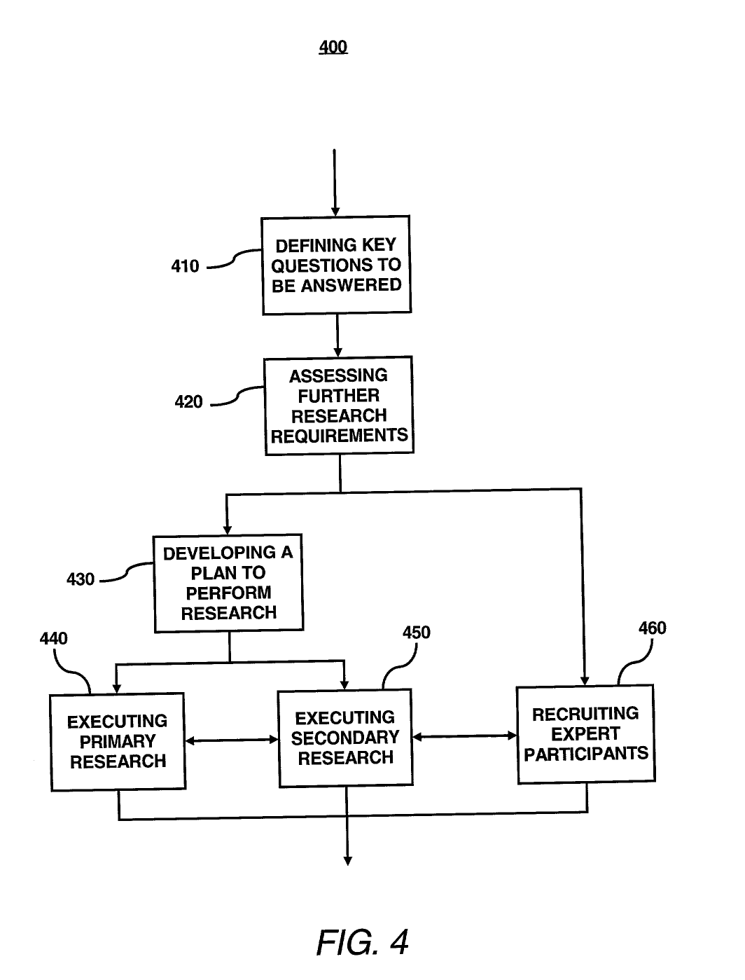

FIG. 4 depicts the step 400 according to an embodiment of the invention. In general, the step 400 may include performing primary and secondary research. For example, as shown in FIG. 4, the step 400 may include a step 410 of synthesizing results from the step 300 and defining key questions to be answered, a step 420 of gathering pre-existing research data from participants and assessing further research requirements, a step 430 of developing a plan to perform research, a step 440 of executing primary research, and a step 450 of executing secondary research on customers, society, businesses, industry and technology trends. The step 400 may further include a step 460 of recruiting expert participants.

The step 410 may be initiated by synthesizing a conclusion based on the goals, customer segments and environments agreed upon in the step 300. Based on the conclusion, the participants of the step 410 may generate one or more pre-work questions to be answered by the ensuing research.

In step 420, the participants may assess whether pre-existing research is sufficient to answer some or all of the one or more pre-work questions. For example, the participants may attempt to answer each pre-work question by referencing the pre-existing research. In this manner, a list or body of required research corresponding to unanswered or relatively poorly answered pre-work questions may be generated.

In step 430, the participants may assign research roles and deadlines based on the list of required research generated in step 420.

In step 440, the participants may execute or perform primary research associated with the required research. Typically, research subjects are utilized in the step 440. For example, one or more representative members of the identified customer segment may be recruited for participation in the primary research. The representative members may be observed interacting with the business opportunity and/or asked questions associated with the business opportunity. Typically, at least part of the primary research approach utilizes qualitative, in-situ, social-science-based research methods.

In step 450, the participants may perform secondary research associated with the required research. In this regard, information related to one or more of customer segments, social, business, industry, technology and services may be referenced to perform the secondary research. For example, the participants may gather data and note a rate of new product introductions in one or more product/service areas (e.g., cameras, mobile phone services, etc.). The rate of new product introductions may indicate a trend. The trend may be used to understand a future environment for the business opportunity. For example, if market trends indicate an increased number of new products while consumer trends indicate reduced or steady sales, the future environment may include little opportunity for growth. Conversely, if market trends indicate a steady or decreased number of new products while consumer trends indicate increased sales, the future environment may include a high growth potential.

In step 460, at least one expert in a field or fields associated with the business opportunity may be consulted. In a preferred embodiment, a team of researchers may be retained to perform some or all of the steps involved in the step 400. More particularly, the team of researchers may identify a group of experts in fields related to customer segments, technologies and/or services associated with the business opportunity. The team of researchers may further prepare the one or more identified experts for presenting to the participants of step 500. The preparation may include asking the experts particular types of questions and giving the experts particular criteria or guidelines to consider when answering the questions. For example, when asked about a particular technology, the expert may be expected to describe the motivations and the environment of the user/consumer and the demographics (i.e., how the environment and use of the product has changed, how the user/consumer has changed, and how the area of purchase/use has changed.). The expert may further identify competition in the particular product/service area.

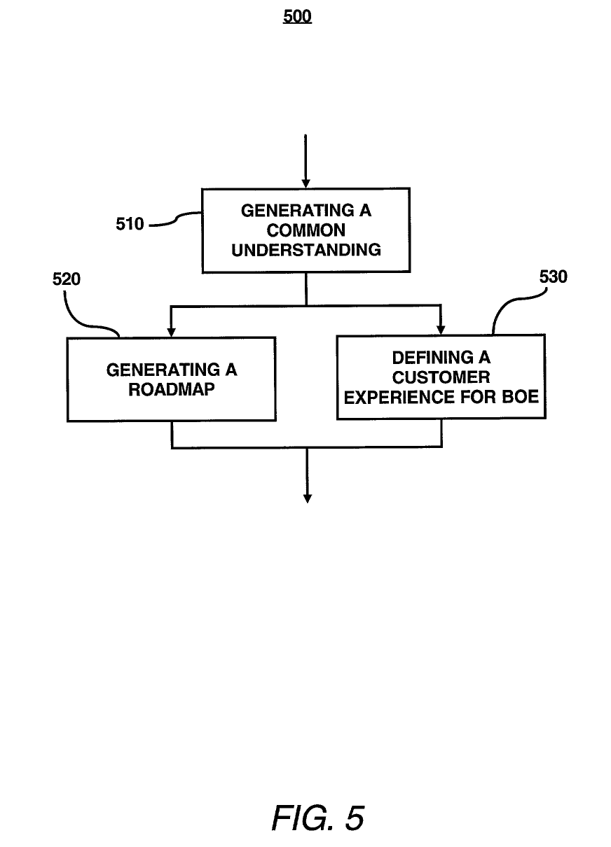

FIG. 5 illustrates the step 500 according to an embodiment of the invention. In general, some or all the step 500 may be performed by participants of a collaborative invent workshop. As illustrated in FIG. 5, the step 500 may include a step 510 of generating a common understanding of the research and choosing an initial focus area, a step 520 of generating a roadmap and development of a strategic business plan associated with the business opportunity, and a step 530 of defining a customer experience associated with the BOE.

Typically, the participants of the step 500 identify and begin developing a strategic business plan. In this regard, the participants of the step 510 may give one or more presentations relating information gathered to date. In general, the intent of the presentations is to provide a base of information for the participants to form a common understanding of the research. Based on the information given, the participants may choose the initial focus area. For example, an area identified as important to the success of the method 100 or an area not well understood may be defined as an initial focus area.

To increase knowledge and/or understanding in the initial focus area, exercises may be performed. For example, in an ideal future exercise, the participants may develop an “ideal” outcome for the customer segments and the business interests, ascertain products and/or services associated with attaining the “ideal” outcome, and identify “key” events that should take place in order for the outcome to occur. Basically, the ideal future exercise is a tool involved in the steps 520, and 530.

Another exercise that may be performed is “horizoning”. For example, a phased vision action plan may be developed. Each phase represents a horizon and the act of describing each phase and the interactions of the various phases is defined as “horizoning”. In general, the phased vision action plan is used to break down goals into manageable subsets of tasks. Preferably, each task of the manageable subsets of tasks should be relatively easy to accomplish and the completion of the task verifiable. Typically, the phased vision action plan is an aspect of the strategic business plan.

In step 520, the participants may develop the strategic business plan based on the outcome of the above performed exercises. Additionally, the participants may define the customer experience associated with the BOE in step 530. In general, the steps 520 and 530 lay the groundwork for the step 1000. Thus, as more information is gathered, the concepts initiated in the steps 520 and 530 may be modified in subsequent steps of the method 100 and particularly in the step 1000.

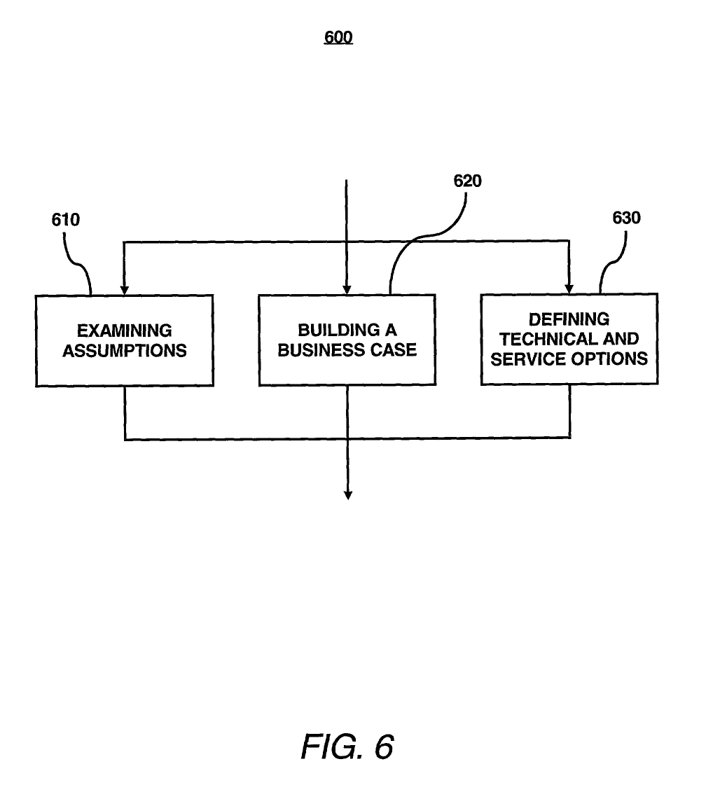

FIG. 6 shows the step 600 according to an embodiment of the invention. As shown in FIG. 6, the step 600 may include a step 610 of examining assumptions, a step 620 of building a business case, and a step 630 of defining technical and service options associated with the business opportunity. In one form, some or all of the steps involved in the step 600 may not be performed. For example, if insufficient information has been gathered to formulate worthwhile assumptions, the step 610 may not be performed. In this regard, the method 100 may continue, additional information gathered, and unperformed steps involved in the step 600 may be performed once adequate data is acquired. Similarly, the steps 620, and 630 may be performed as adequate information is accumulated.

Once it is determined that adequate information has been accumulated, the step 610 may be performed. In a preferred form, assumptions made during the method 100 may be listed and prioritized. For example, identified assumptions may be placed on a list. Assumptions made with relatively less data or that are relatively more important may be placed relatively higher on the list than other assumptions. The listed assumptions may then be examined based on any additional information gathered.

The step 620 may involve identifying partners, obtaining supply inventories for the identified partners and tabulating expected expenditures and revenues. In a preferred form, sufficient information with regard to product design and manufacture may be required to tabulate meaningful expected expenditures. Similarly, projected product cost and sales figures may be required to formulate expected revenues. The step 620 may, in part, depend on a favorable relationship of expected revenues as compared to expected expenditures.

The participants of the step 630 may determine a plurality of technical/service options that may be utilized by the business interest to produce the business opportunity. The participants may further determine one or more preferred technical/service options by comparing and contrasting each technical/service option of the plurality of technical/service options.

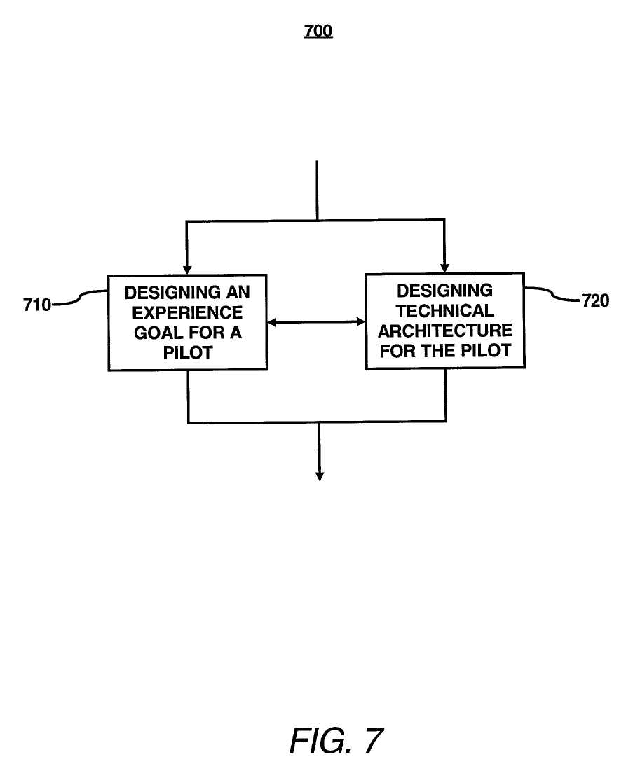

FIG. 7 depicts the step 700 according to an embodiment of the invention. As depicted in FIG. 7, the step 700 may include a step 710 of designing an experience goal associated with a pilot and a step 720 of designing technical architecture associated with the pilot. The step 710 comprises, essentially, the idea of determining what possible uses the technology could achieve in the BOE as generally envisioned by the participants of the step 500, and more particularly, the customer experience outlined by the participants of the step 530. The participants of the step 710 may then determine which, if any, ideas from the step 530 are feasible, possibly based in part on the assessments of the technical options in the step 630. The ideas determined to be feasible act as a charge to the participants (e.g., design team) designing the technical architecture associated with the pilot in the step 720. These designs may be utilized as the “blue print” for a prototype of the BOE that include any real technology or research that could prove the feasibility of the BOE in a way that is tangible to any of the management, the inventors, or, more generally, any entity that interacts with or is associated with the BOE.

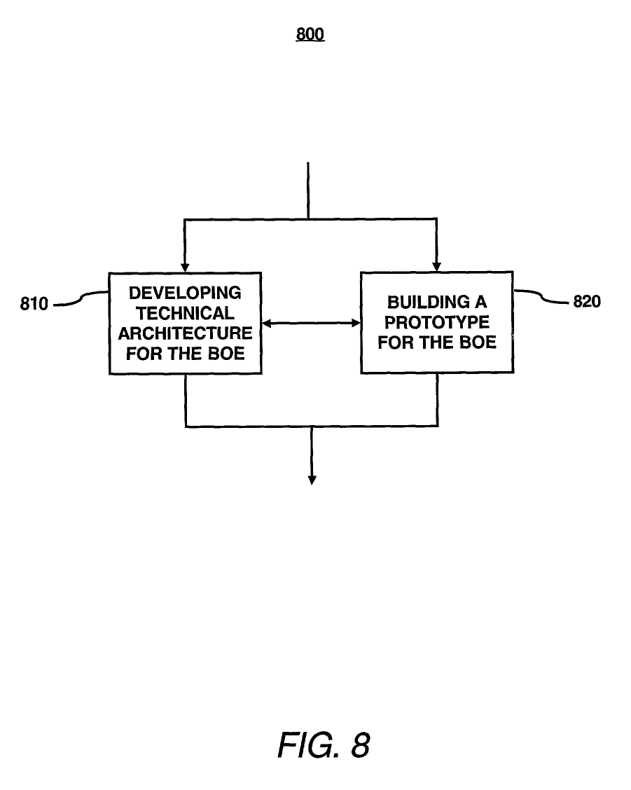

FIG. 8 illustrates the step 800 according to an embodiment of the invention. As depicted in FIG. 8, the step 800 may include a step 810 of developing technical architecture associated with the BOE and a step 820 of building a prototype associated with the BOE.

The technical architecture developed in the step 810 may include any infrastructure, backbone, or any end-user technology or services needed to implement the designs agreed upon by the participants of the step 720. The technical architecture may be utilized by the participants of the step 820 to build a prototype of the designs developed by the participants of step 720.

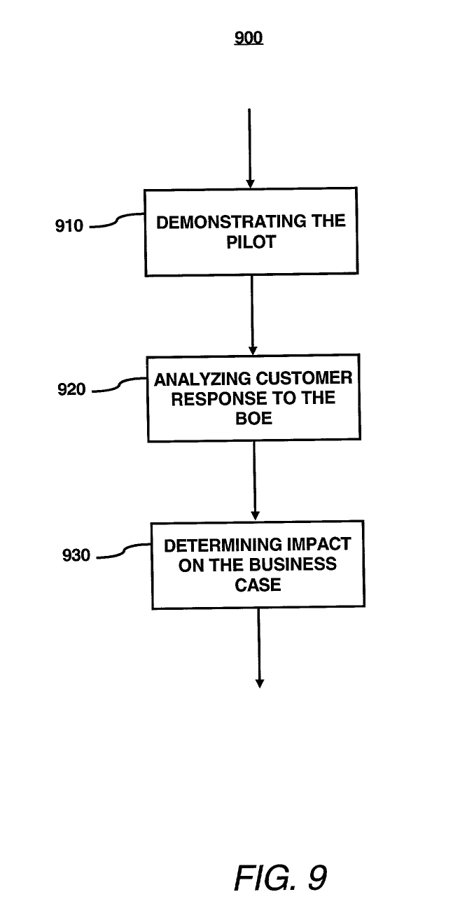

According to an embodiment of the invention, the step 900 may include as shown in FIG. 9, a step 910 of demonstrating the pilot as a proof of concept, a step 920 of analyzing customer response to the BOE, and a step 930 of determining impact on the business case.

The step 910 may include identifying potential customers to participate in a market study or survey in which they interact with the prototype and provide feedback, or it might include the rollout of the product to a small area to see what the response to it is under regular market conditions. In any case, the response to the prototype is analyzed in step 920 by using market and customer analysis tools known in the trade. The results are then used to determine what, if any, features of the business case should be changed. The business case is defined as the conglomeration of technologies, marketing or pricing schemes, or any other aspect of the designs determined by the participants of the step 720.

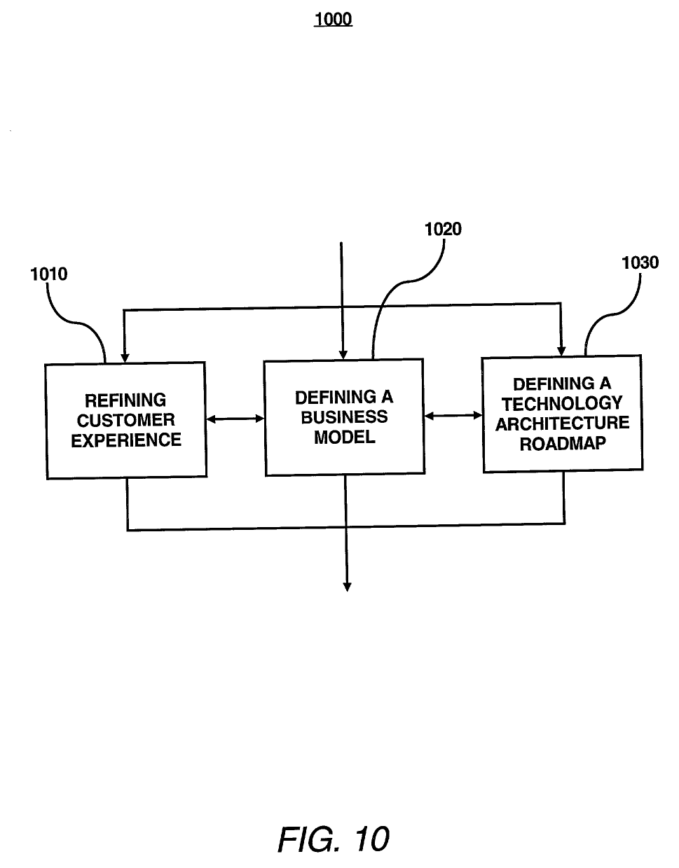

FIG. 10 shows the step 1000 according to an embodiment of the invention. In general, the participants of the step 1000 are expected to create a vision and strategy road map based on the results of the analysis of the response to the prototype determined in step 920 As depicted in FIG. 10, the step 1000 may include a step 1010 of refining a substantially total customer experience, a step 1020 of defining a business model, and a step 1030 of defining a technology architecture roadmap.

The step 1010 may comprise determining at least a subset of the ways in which the customer experience with the BOE may be improved. In this regard, now that more information and data has been acquired, the participants of the step 1010 may modify the customer experience defined in step 530. The participants of the step 1020 may utilize this information to determine how to proceed with the business case. Various methods for defining a business model are well known in the trade, and those with knowledge in the trade will be able to realize that any of these methods may be utilized at this stage. The participants of the step 1030 may utilize the information defined in step 1020 to outline how all of the technology and services will interact. The step 1000 may be an iterative process capable of change as new data is analyzed based on the demonstration of the BOE in step 900.

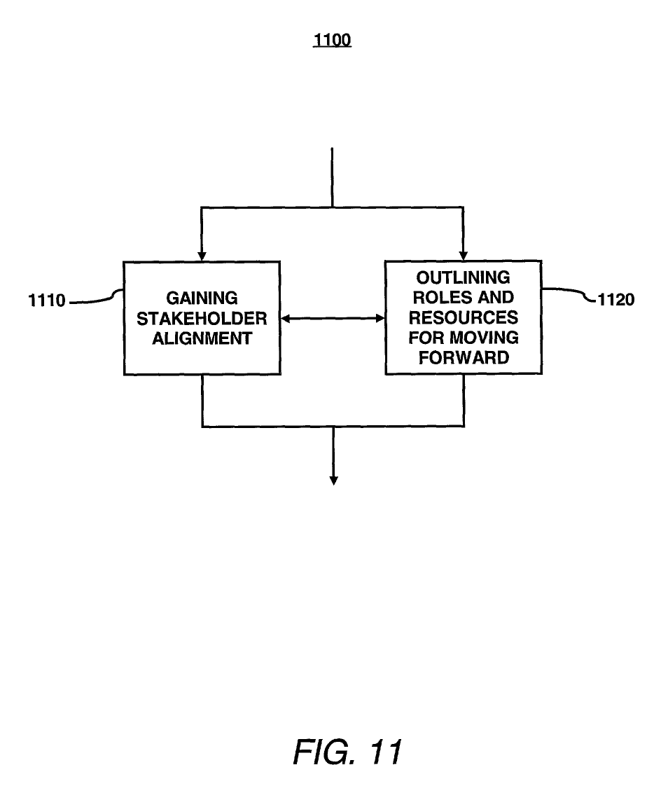

FIG. 11 depicts the step 1100 according to an embodiment of the invention. As depicted in the FIG. 11, the step 1100 may include a step 1110 of gaining alignment from key stakeholders and a step 1120 of outlining roles and resources associated with moving forward. These elements of these steps would be known to one with reasonable knowledge in the trade. One goal of the alignment meeting 1100 may be to ensure that all of the entities (e.g., business interests, participants, etc.) involved in the initiation meeting performed in step 200 are interested in the continued pursuit of the design of the BOE as laid out in step 700 and refined in step 1000, thus gaining alignment from key stakeholders. Another purpose for the alignment meeting may be similar to the function described above except with a subset of those original entities, or even the addition of new stakeholders. Additionally, decisions performed by the participants of the step 1110 may be to determine which goals described in steps 320 and 710 had been met at this point, and to ensure that all stakeholders had fulfilled their respective roles assigned in step 340 and respective responsibilities assigned in step 350. Once the alignment meeting has taken place, and with the assessment of the current situation in mind, the participants of step 1120 may outline the remaining roles and resources associated with moving forward. The step 1120 may involve determining what remains to be done from any of the previous steps or planning sessions (i.e. steps 520, 530, 810 and 820) or may outline new roles and resources needed for the future steps. For these purposes, roles and resources may have many different meanings. For example, one meaning may include a role being a person or persons responsible for a certain step or steps, and resources may include a person or persons responsible for obtaining the input necessary for a certain step or steps, whether that input be human resources, capital resources, hardware, or any other resource.

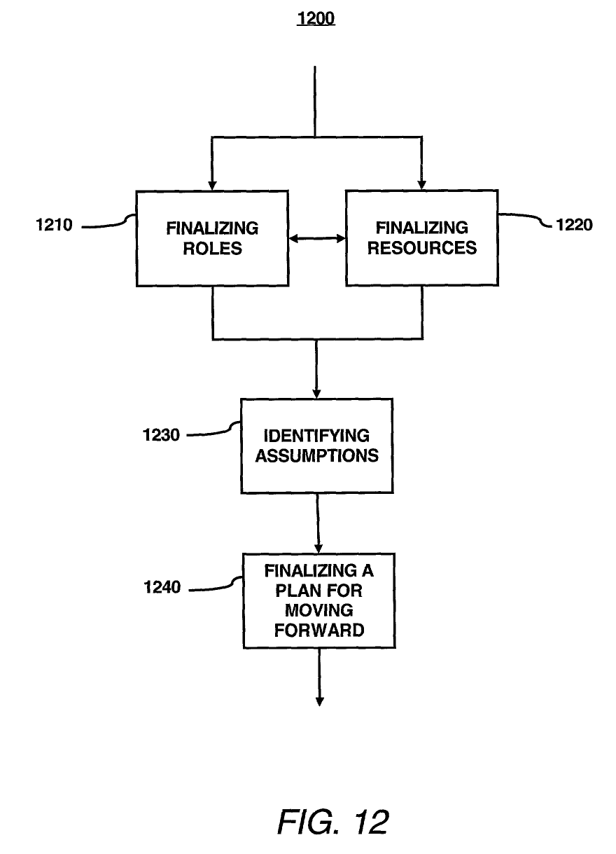

FIG. 12 illustrates the step 1200 according to an embodiment of the invention. As depicted in the FIG. 12, the step 1200 may include a step 1210 of finalizing roles, a step 1220 of finalizing resources, a step 1230 of identifying substantially critical assumptions, and a step 1240 of finalizing a substantially detailed short term plan associated with moving forward. In general, the step 1200 involves creating contracts that outline the commitments of each party that will be involved in going forward. More particularly, these contracts may include at least some of the following steps: the step 1210 and 1220 may comprise reaching an agreement on the outlines set forth previously in step 1120, whether or not those outlines have undergone modifications since their initial outline; the step 1230 may comprise figuring out as much as possible of what is necessary in order for substantially all participants involved to want to continue to go forward. By way of example, a critical assumption made by the participants in the step 1230 may be that the project will be completed before an anticipated event and if that were not to happen, at least one entity would require an alteration to one or more agreements. Once the assumptions made by the participants in the step 1230 are identified, they may be incorporated by the participants of the step 1240 into a detailed short term plan associated with moving forward. Typically, the finalized detailed short term plan associated with moving forward identifies what the next steps must be to keep going with the project to ultimately have a BOE as envisioned upon completion of the demonstration in the step 900 and the refinement of the business plan in the step 1000 and will be explicitly or implicitly agreed upon for the purposes of the commitment meeting in the step 1200.

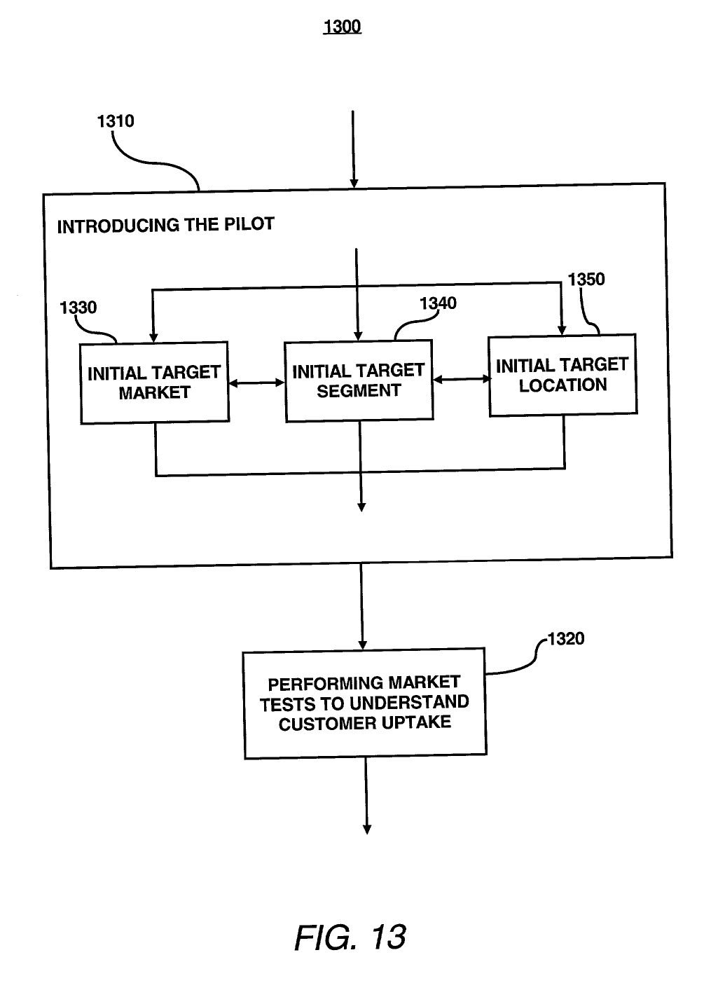

FIG. 13 shows the step 1300 according to an embodiment of the invention. As shown in the FIG. 13, the step 1300 may include a step 1310 of introducing the pilot and a step 1320 of performing limited market tests associated with understanding customer uptake. The step 1310 may be performed on at least one of an initial target market 1330, an initial target segment 1340, and an initial target location 1350. The step 1310 is known to those familiar in the trade and includes methods of releasing products to a market by way of pilot testing. Those familiar with pilot tests of products will appreciate that any method developed in the future for the release of products that is unknown at this time would also work in this step without affecting the purpose or function of this step.

Additionally, the method 100 may exist as software program(s). For example, some or all of the participants, researchers and customers referred to herein may include software agents configured to represent business interests, retrieve information and represent customer interests. In this regard, the software agent(s) may exist in a variety of active and inactive forms. For example, they may exist as software program(s) comprised of program instructions in source code, object code, executable code or other formats. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Concrete examples of the foregoing include distribution of the program(s) on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. For example, the steps illustrated in FIGS. 1-13 may be performed in an order different from the order shown and/or may be performed simultaneously. Those skilled in the art will recognize that these and many other variations are possible within the spirit and scope of the invention, which is intended to be defined by the following claims—and their equivalents—in which all terms are meant in their broadest reasonable sense unless otherwise indicated.

What is claimed is:

1. A method for systematically and consistently developing a business opportunity, the method comprising the steps of:
performing an initiation meeting;
performing a pre-invent session;
performing pre-work;
performing an invent session;
designing a business opportunity environment;
developing the business opportunity environment;
demonstrating the business opportunity environment;
refining a business plan;
performing an alignment meeting;
performing a commitment meeting; and
marketing a pilot.

2. The method of claim 1 wherein the step of performing an initiation meeting further comprises the steps of:
executing an agreement for a collaborative invent process; and
executing an agreement to develop the business opportunity environment.

3. The method of claim 1 wherein the step of performing a pre-invent session further comprises the steps of:
preparing for the invent session;
agreeing on goals;
performing an assessment of existing research data;
negotiating roles; and
assigning responsibilities.

4. The method of claim 1 wherein the step of performing pre-work further comprises the steps of:
defining key questions;
gathering pre-existing research data from participants and assessing further research requirements;
developing a plan to perform research;
executing primary research;
executing secondary research on customer segments, society, businesses, industry and technology trends; and
recruiting expert participation.

5. The method of claim 1 wherein the step of performing the invent session further comprises the steps of:
generating a common understanding of the research and choosing an initial focus area;
generating a roadmap and development of a strategic business plan associated with the business opportunity; and
defining a customer experience associated with the business opportunity environment.

6. The method of claim 1 wherein the step of designing the business opportunity environment further comprises the steps of:
designing an experience goal associated with a pilot; and
designing a technical architecture associated with the pilot.

7. The method of claim I wherein the step of developing the business opportunity environment further comprises the steps of:
developing technical architecture associated with the business opportunity environment; and
building a prototype associated with the business opportunity environment.

8. The method of claim 1 wherein the step of demonstrating the business opportunity environment further comprises the steps of:
demonstrating the pilot as a proof of concept;
analyzing customer response to the business opportunity environment; and
determining impact on the business case.

9. The method of claim 1 wherein the step of refining the business plan further comprises the step of:
defining a substantially total customer experience;
defining a business model; and
defining a technology architecture roadmap.

10. The method of claim 1 wherein the step of performing an alignment meeting further comprises the steps of:
gaining alignment form key stakeholders; and
outlining roles and resources associated with moving forward.

11. The method of claim 1 wherein the step of performing a commitment meeting further comprises the steps of:
finalizing roles;
finalizing resources;
identifying substantially critical assumptions; and
finalizing a substantially detailed short term plan associated with moving forward.

12. The method of claim 1 wherein the step of marketing the pilot further comprises the steps of:
introducing the pilot to at least one of, an initial target market, an initial target segment and an initial target location; and
performing a limited market test associated with understanding customer uptake.

13. The method of claim 1 further comprising the step of validating a business venture.

14. The method of claim 13 wherein the step of validating a business venture further comprises the steps of:
examining assumptions;
building a business case; and
defining technical options.

15. A method for systematically and consistently developing a strategic plan to create high growth business opportunities, the method comprising the steps of:
performing an initiation meeting;
performing a pre-invent session;
performing pre-work;
performing an invent session;
validating a business venture;
designing a business opportunity environment;
developing the business opportunity environment;
demonstrating the business opportunity environment;
refining a business plan;
performing an alignment meeting;
performing a commitment meeting; and
marketing a pilot.

16. The method of claim 15 wherein the step of performing an initiation meeting further comprises the steps of:
executing an agreement for a collaborative invent process; and
executing an agreement to develop the business opportunity environment.

17. The method of claim 15 wherein the step of performing a pre-invent session further comprises the steps of:
preparing for the invent session;
agreeing on goals;
performing an assessment of existing research data;
negotiating roles; and
assigning responsibilities.

18. The method of claim 15 wherein the step of performing pre-work further comprises the steps of:
defining key questions;
gathering pre-existing research data from participants and assessing further research requirements;
developing a plan to perform research;
executing primary research;
executing secondary research on customer segments, society, businesses, industry and technology trends; and
recruiting expert participation.

19. The method of claim 15 wherein the step of performing the invent session further comprises the steps of:
generating a common understanding of the research and choosing an initial focus area;
generating a roadmap and development of a strategic business plan associated with the business opportunity; and
defining a customer experience associated with the business opportunity environment.

20. A computer readable medium on which is embedded computer software comprising a set of instructions for executing a method of systematically and consistently developing a strategic plan to create high growth business opportunities, the method comprising:
performing an initiation meeting;
performing a pre-invent session;
performing pre-work;
performing an invent session;
designing a business opportunity environment;
developing the business opportunity environment;
demonstrating the business opportunity environment;
refining a business plan;
performing an alignment meeting;
performing a commitment meeting; and
marketing a pilot.
